(19) United States
(12) Patent Application Publication
(10) Pub. No.: US 2003/0075707 A1
(43) Pub. Date: Apr. 24, 2003

(54) High performance power cable shield and method of making

(76) Inventor: Mark R. Easter, Indianapolis, IN (US)

Correspondence Address: BLANK ROME COMISKY & MCCAULEY, LLP, 900 17TH STREET, N.W., SUITE 1000, WASHINGTON, DC, 20006, US

(21) Appl. No.: 10/162,067

(22) Filed: Jun. 5, 2002

Related U.S. Application Data
(60) Provisional application No. 60/295,830, filed on Jun. 6, 2001.

(51) Int. Cl. H01C 1/00

(52) U.S. Cl. 252/511

(57) ABSTRACT

An improved conductor shielding composition for power cables and a method of forming such a composition into a conductor shield with improved smoothness and electrical properties are disclosed. The composition includes a base polymer, conductive carbon black and a block copolymer of ethylene oxide and propylene oxide.

### BACKGROUND OF THE INVENTION

1. Technical Field of the Invention

This invention relates to methods and compositions useful in the preparation of semiconductive conductor shields in power cables and to semiconductive conductor shields and power cables utilizing the composition.

2. Description of the Related Art

A typical insulated electric power cable generally comprises a conductor in a cable core that is surrounded by several layers of polymeric materials including an inner semiconducting shield layer (conductor or strand shield), an insulating layer, an outer semiconducting shield layer (insulation shield), a metallic wire or tape shield used as the ground phase, and a protective jacket. Additional layers within this construction such as moisture impervious materials, are often incorporated. The invention pertains to the inner semiconducting shield layer, i.e., the conductor shield.

Semiconductive shields have been used in power cables as shields for the cable conductor and insulation for many years. The conductor shield is typically extruded over the cable conductor to provide a layer of intermediate conductivity between the conductor and cable insulation in the power cable. Conventional compositions for these conductor shields include a base polymer as the predominant component of the composition compounded with, carbon black to provide conductivity for the composition and various additives.

The primary purpose of the semiconducting conductor shield between the conductor and insulation in an electrical power cable is to ensure the long term viability of the primary insulation. There is always a need for improved semiconductive conductor shield compositions that balance cost and performance. This is true not only for the cost of the additives, but also the means employed to process a composition into the conductor shield.

Examples of polymer compositions used as shields in power cables are found in the disclosures of U.S. Pat. Nos. 4,612,139 and 4,305,846 to Kawasaki et al., U.S. Pat. No. 4,857,232 to Burns, Jr., U.S. Pat. No. 3,849,333 to Lloyd et al., U.S. Pat. No. 5,889,117 to Flenniken, U.S. Pat. No. 5,725,650 to Flenniken et al, and U.S. Pat. No. 6,086,792 to Reid et al., the disclosures of which are hereby incorporated by reference.

In particular, processes for pelletizing carbon for use in various polymer compositions are known and disclosed in U.S. Pat. No. 5,725,650 as well as in U.S. Pat. Nos. 5,872,177 and 5,871,706 to Whitehouse. The Whitehouse patents demonstrate the use of a wet process whereby various ethoxylated esters or polyethers are used with fluffy carbon black in a wet pelletizing process.

It would be desirable to have a conductor shield composition and a method of forming such a composition into a conductor shield with improved smoothness and electrical properties. It would further be desirable to have a conductor shield composition and a method of forming such a composition into a conductor shield with improved smoothness and electrical properties without the need for a wet pelletizing process for the carbon black.

### SUMMARY OF THE INVENTION

The invention provides a conductor shield composition and a method of forming such a composition into a conductor shield with improved smoothness and electrical properties. The invention also provides a dry solvent-free process for forming such a composition into a conductor shield with improved smoothness and electrical properties and thus avoids the need for any wet pelletizing process step for the carbon black.

In particular, the composition of the invention, conductor shields and cables made with conductor shields in accordance with the invention exhibit superior performance over time as demonstrated by accelerated cable life testing (ACLT) as compared to conventional high performance conductor shield compositions.

The invention also provides conductor shields having dramatically improved smoothness.

In particular, the invention provides a conductor shield comprising a base polymer selected from the group consisting of copolymers of ethylene and a mono-unsaturated ester, copolymers of ethylene and one or more alpha olefins having three to six carbon atoms, EPR and EDPM rubbers, low density polyethylene and linear low density polyethylene; conductive carbon black; and a block copolymer of ethylene oxide and propylene oxide.

In addition to the composition of matter, the invention includes a semiconductive shield for the conductor or insulation in a power cable formed by extruding the composition over the conductor or insulation of the power cable and the resulting power cable that employs the composition as a conductor shield.

The invention also provides a dry process for forming a conductor shield composition having improved smoothness and electrical properties on a conductive element comprising the steps of combining a base polymer together with conductive carbon black and a block copolymer of ethylene oxide and propylene oxide in the absence of a liquid solvent to form a conductor shield composition and forming said composition onto a conductor to form a conductor shield.

### DETAILED DESCRIPTION OF THE PREFERRED EMBODIMENT

The base polymer of the composition of the invention can be selected from a variety of polymers including various homopolymers, copolymers and terpolymers known in the art, the selection being based upon the ultimate desired use of the polymer composition. For example, the polymers used in the polymeric compositions of the present invention may include, but are not limited to, homopolymers, copolymers and graft polymers of ethylene where the co-monomers are selected from butene, hexene, propene, vinyl acetate, acrylic acid, methacrylic acid, esters of acrylic acid, esters of methacrylic acid, maleic anhydride, half esters of maleic anhydride, carbon monoxide and the like; elastomers selected from natural rubber, polybutadiene, polyisoprene, random styrene butadiene rubber, polychloroprene, nitrile rubbers, ethylene propylene copolymers and terpolymers and the like; homopolymers and copolymers of styrene, including styrene-butadiene, styrenebutadiene-styrene linear and radial polymers, acrylonitrile-butadiene-styrene, styrene acrylonitrile and the like; linear and branched polyether or polyester polyols; crystalline and amorphous polyesters and polyamides; alkyd resins, rosin acids or rosin esters; hydrocarbon resins produced from thermal or Friedal Crafts polymerization of cyclic diene monomers such as dicyclopentadiene, indene, cumene and the like; ethylene/silane copolymers; ethylene/.alpha.-olefin/diene terpolymers such as ethylene/propylene/1,4hexadiene, ethylene/1-butene/1,4-hexadiene and the like; mixtures thereof and the like. Additionally, the polymer used in compositions of the present invention may include copolymers and terpolymers containing the above-identified polymers as major components of the copolymer or terpolymer.

Preferably, the base polymer of the composition of the invention is selected from a variety of polymers including copolymers of ethylene and a mono-unsaturated ester such as ethylene-ethyl acrylate, ethylene-methyl acrylate, ethylene-methyl methacrylate and ethylene-vinyl acetate, copolymers of ethylene and one or more alpha olefins having three to six carbon atoms, as well as EPR and EDPM rubbers, low density polyethylene (LDPE) and linear low density polyethylene (LLDPE). Of these copolymers, ethylene-vinyl acetate (EVA) is more preferred. More particularly, EVA having a vinyl acetate content between 18% and 20% is most preferred for use as the base polymer of the invention. The base polymer may be on the order of 40 weight percent to 80 weight percent of the composition according to the invention, preferably from 50 weight percent to 70 weight.

In the present invention, carbon black is added to the polymer compositions to impart semi-conductive properties to the composition. The carbon black added to the polymer may be any of the various available carbon blacks. Thus any of a wide variety of carbon blacks may be used in the present invention, including finely divided carbon such as lamp black, furnace black, or acetylene black, i.e. carbon black made by pyrolyzing acetylene. A key benefit of the invention is the avoidance of the carbon wet pelletizing step, and consequently to avoid problems and cost associated with making and handling carbon black pellets made by such a wet pelletizing step. For example, the water used in the wet pelletizing process can introduce ionic and/or mineral contaminants into the conductor shield composition which can adversely affect electrical properties and/or longevity. Accordingly, in the composition and method according to the invention dry pelletized carbon black, or carbon black in its fluffy form, may be used. The carbon black is generally present in the composition in the amount of from about 0.1% to about 60% by weight of the polymer composition. Preferably the carbon black is present in an amount of from about 25% to about 50% by weight, based on the weight of the total composition.

A tremendous number of compounds have been suggested for use as additives in semiconducting shield compositions. Typically, these compounds fall into the category of antioxidants, curing agents, vulcanizing agents, crosslinking agents, boosters and retardants, processing aids, pigments, dyes, colorants, fillers, coupling agents, ultraviolet absorbers or stabilizers, antistatic agents, nucleating agents, slip agents, plasticizers, lubricants, viscosity control agents, tackifiers, anti-blocking agents, surfactants, extender oils, acid scavengers, and metal deactivators.

The present invention is based upon the discovery that certain block copolymers of ethylene oxide and propylene oxide produce a shield composition having improved smoothness as measured by Uninop® (a quantitative laser method of surface smoothness profiling which provides a measure of the dimensions of surface defects on a micron level) methods as well as enhanced electrical aging performance as measured by accelerated cable life testing (ACLT). In embodiments of the invention, the block copolymers of ethylene oxide (EO) and propylene oxide (PO) may have a structure wherein the propylene oxide block is sandwiched between two ethylene oxide blocks (EO/PO/EO). Alternately, in embodiments of the invention, the block copolymers of ethylene oxide (EO) and propylene oxide (PO) may have a structure wherein the ethylene oxide block is sandwiched between two propylene oxide blocks (PO/EO/PO).

In further embodiments of the invention, the block copolymer has an average molecular weight from about 5,000 to about 10,000, and preferably from 7,000 to about 9,000. In embodiments of the invention the block copolymer has about 10% to about 90% by weight of ethylene oxide, preferably about 70% to about 90% by weight of ethylene oxide and most preferably about 80% by weight of ethylene oxide. The copolymer may be from about 0.25% to about 5.0% by weight of the composition, preferably from about 0.5% to about 1.0% by weight of the composition.

Specific examples of block copolymers of ethylene oxide and propylene oxide in accordance with the invention are ethylene oxide/propylene oxide block copolymer products marketed by BASF Corporation of Mount Olive, N.J. under the trade name PLURONIC® (such as, for example, PLURONIC F38®, PLURONIC F68®, PLURONIC F98® and PLURONIC F108®).

In the case of the PLURONIC® product line of copolymers, each compound is identified by an alphabetical designation followed by a numerical designation. The alphabetical designations L, P and F indicate the physical form of the product (Liquid, Paste or Flaked). The last integer or integer and fractional digit in the numerical designation of an individual compound indicates approximate weight % poly(oxyethylene)hydrophile in the total molecule multiplied by 0.1. The digit or digits preceding the last integer or integer and fractional digit (or the first digit/s following the alphabetical designation) indicate approximate molecular weight of the poly(oxypropylene)hydrophobe divided by 300.

The relative level of improvement the invention provides to the smoothness of the conductor shields formed from the compositions of the invention in accordance with the process of the invention depends upon the particular carbon black that is used. The most significant improvements result from the use of the particular block copolymers of the invention with acetylene black. For example, the composition of the invention may have a Uninop® smoothness value of less than 300 when the carbon black is acetylene black, more preferably having a Uninop® smoothness value of less than 100. Also, when acetylene carbon black is used the improved Uninop® smoothness value represents less than 5% of the comparative Uninop® value for an identical composition not having the block copolymer. Put another way, the smoothness is around twenty times improved in comparison to the composition not having the block copolymer. In other embodiments of the invention the smoothness improvement is less pronounced, for example on the order of about a 20% improvement when using carbon blacks such as Raven C carbon black.

The following chart illustrates carbon black properties of several carbon blacks that may be used in the composition and method according to the invention:

Carbon blacks with a lower DBP value and higher particle size may require greater amounts of the block copolymer of ethylene oxide and propylene oxide according to the invention, depending on the particular process of manufacture. In general a higher DBP value, which is a measure of the aggregate size and shape, makes a carbon black easier to disperse. A higher particle size value is also representative of a carbon black that is easier to disperse. A smaller particle size is related to higher surface area and makes a carbon black harder to disperse. In embodiments of the invention, the carbon black has a particle size of from about 20 nm to about 40 nn. In embodiments of the invention, the carbon black has a DBP value of at least about 110 ml/100 g. Carbon blacks in accordance with the invention may be either in fluffy form or may be dry pelletized.

| | | | Acetylene |
|---|---|---|---|
| | Ensaco 250 | Raven C | Black |
| DBP ml/100 g | 190 | 114 | 180 |
| Nitrogen | 65 | 123 | 63 |
| surface area | | | |
| m²/g | | | |
| Particle size | 40 | 20 | 35 |
| mm | | | |
| 325 sieve | 2 | 200 | 0.1 |
| residue ppm | | | |

Examples of antioxidants are as follows, but are not limited to: hindered phenols such as tetrakis[methylene(3,5-di-tert-butyl-4-hydroxyhydro-cinnamate)] methane; bis[(beta-(3,5-ditert-butyl-4-hydroxybenzyl)-methylcarboxyethyl)]sulphide; 4,4′-thiobis(2-methyl-6-tert-butylphenol), 4,4′-thiobis(2-tert-butyl-5-methylphenol), 2,2′-thiobis(4-methyl-6-tert-butylphenol), and thiodiethylene bis(3,5-di-tert-butyl-4-hydroxy)hydrocinnamate; phosphites and phosphonites such as tris(2,4-di-tert-butylphenyl)phosphite and di-tert-butylphenyl-phosphonite; thio compounds such as dilaurylthiodipropionate, dimyristylthiodipropionate, and distearylthiodipropionate; various siloxanes; polymerized 2,2,4-trimethyl-1,2-dihydroquinoline (TMQ), n,n′-bis(1,4-dimethylpentyl-p-phenylenediamine), alkylated diphenylamines, 4,4′-bis(alpha, alpha-dimethylbenzyl)diphenylamine, diphenyl-p-phenylenediamine, mixed di-aryl-p-phenylenediamines, and other hindered amine antidegradants or stabilizers. Antioxidants can be used in amounts of about 0.1 to about 5 percent by weight based on the weight of the composition.

Examples of curing/crosslinking agents are as follows: dicumyl peroxide; bis(alpha-t-butyl peroxyisopropyl)benzene; isopropylcumyl t-butyl peroxide; t-butylcumylperoxide; di-t-butyl peroxide; 2,5-bis(t-butylperoxy)2,5-dimethylhexane; 2,5-bis(t-butylperoxy)2,5-dimethylhexyne-3; 1,1-bis(t-butylperoxy)3,3,5-trimethylcyclohexane; isopropylcumyl cumylperoxide; di(isopropylcumyl) peroxide; or mixtures thereof. Peroxide curing agents can be used in amounts of about 0.1 to 5 percent by weight based on the weight of the composition.

The polymer compositions of the present invention are manufactured without using any aqueous or non-aqueous liquid solvent, i.e., they are manufactured “dry”. The compositions and method according to the invention employs conventional machinery to produce the final composition according to the invention. The compositions may be prepared by batch or continuous mixing processes, for example, equipment such as Banbury mixers, Buss co-kneaders, and single or twin screw extruders may be used to mix the ingredients of the formulation. The components of the polymer compositions of the present invention may be mixed and formed into pellets for future use in manufacturing electrical cable.

The composition of the invention, and conductor shields and cables made with conductor shields in accordance with the invention exhibit superior performance over time as demonstrated by accelerated cable life testing (ACLT) as compared to conventional high performance conductor shield compositions.

Furthermore, the composition of the invention when used in a conductor shield may achieve a count of surface imperfections/m² of 300 or less, preferably a count of surface imperfections/m² of 100 or less.

In addition, the composition and method according to the invention provide improvements in screen life and extruder torque.

To further illustrate the advantageous features of the invention, the following non-limiting examples are provided.

### EXAMPLES 1 TO 6

Examples 1 to 6 were prepared with a 46 mm laboratory scale Buss Co-Kneader. The compositions were made with about 61 to 62 weight percent (refer to the chart for exact percentages) base polymer resin Elvax 450 18% vinyl acetate content EVA resin having a melt index of 8.38 weight percent acetylene black was used with the additives indicated.

| EXAMPLE | 1 | 2 | 3 | 4 | 5 | 6 |
|---|---|---|---|---|---|---|
| acetylene | 38 | 38 | 38 | 38 | 38 | 38 |
| black | | | | | | |
| 18% VA | 62 | 61.5 | 61 | 61 | 61 | 61.6 |
| resin | | | | | | |
| Pluronic | | .5 | | | | |
| F68 | | | | | | |
| dioctyl | | | 1 | | | |
| sebacate | | | | | | |
| AC629 | | | | 1 | | |
| AC573 | | | | | 1 | |
| titanium | | | | | | 4 |
| dimeth- | | | | | | |
| acrylate | | | | | | |
| oxyacetate | | | | | | |
| Uninop | 6,610 | 256 | 3,189 | 3,533 | 5,222 | 3,369 |
| smoothness | | | | | | |
| count | | | | | | |

AC629 is an oxidized PE wax, acid number 15 (ASTM D-1386). AC573 is an ethylene maleic anhydride copolymer wax. Both are manufactured by Honeywell Corporation.

Example 2 according to the invention demonstrates remarkably improved smoothness.

### EXAMPLES 7 TO 11

The following compositions included the same base polymer as in Examples 1 to 6. Raven C carbon black was substituted for the acetylene black. The compositions were mixed in a Banbury mixer, pelletized and extruded through a 500 and 325 mesh screens.

| EXAMPLE | 7 | 8 | 9 | 10 | 11 |
|---|---|---|---|---|---|
| Raven C | 38 | 38 | 38 | 38 | 38 |
| carbon | | | | | |
| black | | | | | |
| 18% VA | 62 | 61 | 61 | 61 | 61 |
| resin | | | | | |
| Pluronic | | 1 | | | |
| F38 | | | | | |
| Pluronic | | | 1 | | |
| F68 | | | | | |
| Pluronic | | | | 1 | |
| F98 | | | | | |
| Pluronic | | | | | 1 |
| F108 | | | | | |
| minutes to | 12.1 | 9.4 | 10.9 | 10.6 | 9.6 |
| 3000 psi | | | | | |
| pressure | | | | | |
| rise, 500 M | | | | | |
| ΔP, psi | 230 | 166 | 107 | 147 | 98 |
| 325 M | | | | | |
| Uninop | 35,317 | 36,639 | 27,772 | 41,545 | 48,379 |
| smoothness | | | | | |
| count | | | | | |

### EXAMPLES 12 TO 13

Compositions including the same base polymer as in Examples 1 to 6 and acetylene black were mixed on a 140 mm Buss Co-Kneader. Example 13 included 1 wt % Pluronic F68 and had a Uninop smoothness count of 79. Example 15 with no block copolymer had a Uninop smoothness count of 1756.

### EXAMPLES 14 TO 23

Examples 14 to 23 were conducted to demonstrate screen life on an extruder with 325 and 500 mesh screens. The compositions were made with 61 or 62 weight percent (depending upon whether 1% block copolymer was used) base polymer resin Elvax 450 18% vinyl acetate content EVA resin having a melt index of 8.38 weight percent carbon black (either Ensaco 250 or acetylene black) was used with the additives indicated.

| | 325-Mesh, | 500-Mesh, |
|---|---|---|
| | psi/Kg | psi/kg |
| Ensaco 250, | 22 | 335 |
| No Additive | | |
| Ensaco 250 + 1% F38 | 48 | 149 |
| Ensaco 250 + 1% F68 | 63 | 107 |
| Ensaco 250 + 1% F98 | 10 | 114 |
| Ensaco 250 + 1% F108 | 39 | 20 |
| Acetylene Black, | 65 | 119 |
| No Additive | | |
| Acetylene Black + 1% F38 | 92 | 80 |
| Acetylene Black + 1% F68 | 88 | 12 |
| Acetylene Black + 1% F98 | 40 | 17 |
| Acetylene Black + 1% F108 | 12 | 119 |

### EXAMPLES 24 AND 25

The following cable shield compositions were prepared with a production scale 146 mm Buss Co-Kneader to demonstrate the improved Uninop® smoothness and ACLT values obtained with the process and compositions of the invention. The EVA base polymer had an vinyl acetate content of 20%. Nine identical samples were submitted for ACLT time-to-failure testing from Comparative Example 24 and five identical samples were submitted for ACLT time-to-failure testing from Example 25 in accordance with the invention.

| Ingredient (wt %) | Comp. Example 24 | Example 25 |
|---|---|---|
| EVA base resin | 59.25% | 58.75% |
| Pluronic F68 | | 0.75% |
| Acetylene black | 38% | 38% |
| TMQ antioxidant | 1% | 1% |
| Uninop ® smoothness | 1064 | 190 |
| Weibull Alpha Life (ACLT) | 158 days | 190 days |

Remarkably improved smoothness and ACLT values at ACLT conductor-in-water test temperatures of are 75° C. obtained by the compositions and process of the invention as demonstrated by the above data. The raw data used to generate the ACLT values is expressed in days to failure and the nine values for the nine cable samples of Comparative Example 25 were 80, 121, 131, 150, 172, 242, 243, 254 and 278 days to failure. The raw data used to generate the ACLT values for Example 25 in accordance with the invention were 160, 180, 199, 207 and 230 days to failure.

### EXAMPLES 26 AND 27

Comparative Example 26 was prepared in exactly the same manner as Comparative Example 24 and Example 27 was prepared in exactly the same manner as Example 25 in order to demonstrate the dramatically improved ACLT performance of the process and compositions of the invention at elevated temperatures with the conductor in air. Nine identical samples were submitted for ACLT time-to-failure testing from Comparative Example 26 and nine identical samples were submitted for ACLT time-to-failure testing from Example 27 in accordance with the invention.

Remarkably improved ACLT values at elevated ACLT conductor-in-air test temperatures of are 90° C. are obtained by the compositions and process of the invention as demonstrated by the following data. The raw data which will be used to generate the ACLT values is expressed in days to failure and the seven values for the nine cable samples of Comparative Example 27 were 199, 240, 244, 254, 256, 260 and 279 with the two remaining samples on test as of 304 days. The four values of raw data which will be used to generate the ACLT values for Example 27 in accordance with the invention are 341, 343, 353 and 360 with a remarkable five samples remaining on test without failure as of 342 days.

What is claimed is:

1. A conductor shield composition having improved smoothness and electrical properties, said conductor shield comprising: a base polymer selected from the group consisting of copolymers of ethylene and a mono-unsaturated ester, copolymers of ethylene and one or more alpha olefins having three to six carbon atoms, EPR and EDPM rubbers, low density polyethylene and linear low density polyethylene; conductive carbon black; and a block copolymer of ethylene oxide and propylene oxide.

2. The composition of claim 1, wherein said block copolymer has a structure wherein a propylene oxide block is sandwiched between two ethylene oxide blocks.

3. The composition of claim 1, wherein said block copolymer has an average molecular weight from about 5,000 to about 10,000.

4. The composition of claim 1, wherein said block copolymer has about 10% to about 90% by weight of ethylene oxide.

5. The composition of claim 4, wherein said block copolymer has about 70% to about 90% by weight of ethylene oxide.

6. The composition of claim 1, wherein said block copolymer is from about 0.5% to about 5.0% by weight of the composition.

7. The composition of claim 1, wherein said base polymer is a copolymer of ethylene and vinyl acetate and has a vinyl acetate content between 18% and 20%.

8. The composition of claim 1 having an improved accelerated cable life testing Weibull Alpha value, in comparison to an identical composition not having said block copolymer.

9. The composition of claim 1 having a Uninop smoothness value of less than 30,000.

10. The composition of claim 1 having a Uninop smoothness value of less than 300 wherein said carbon black is acetylene black.

11. The composition of claim 1 having a Uninop smoothness value of less than 100 wherein said carbon black is acetylene black.

12. The composition of claim 10 wherein said improved Uninop smoothness value represents less than 5% of the Uninop value for an identical composition not having said block copolymer.

13. The composition of claim 11 wherein said improved Uninop smoothness value represents less than 5% of the Uninop value for an identical composition not having said block copolymer.

14. A dry process for forming a conductor shield composition having improved smoothness and electrical properties on a conductive element comprising the steps of:
combining a base polymer selected from the group consisting of copolymers of ethylene and a mono-unsaturated ester, copolymers of ethylene and one or more alpha olefins having three to six carbon atoms, EPR and EDPM rubbers, low density polyethylene and linear low density polyethylene; together with conductive carbon black and a block copolymer of ethylene oxide and propylene oxide in the absence of a liquid solvent to form a conductor shield composition;
and forming said composition onto a conductor to form a conductor shield.

15. The dry process of claim 14 wherein said block copolymer has a structure wherein a propylene oxide block is sandwiched between two ethylene oxide blocks.

16. The dry process of claim 14 wherein said block copolymer has about 10% to about 90% by weight of ethylene oxide.

17. The dry process of claim 14 wherein said conductor shield has an improved accelerated cable life testing Weibull Alpha value, in comparison to an identical composition not having said block copolymer.

18. The dry process of claim 14 wherein said conductor shield has a Uninop smoothness value of less than 300 wherein said carbon black is acetylene black.

19. The dry process of claim 14 wherein said conductor shield has a Uninop smoothness value of less than 100 wherein said carbon black is acetylene black.

20. The dry process of claim 19 wherein said improved Uninop smoothness value represents less than 5% of the Uninop value for an identical composition not having said block copolymer.
